(19) United States
(12) Patent Application Publication
(10) Pub. No.: US 2017/0241122 A1
(43) Pub. Date: Aug. 24, 2017

(54) SEWER INLET COUPLER AND HOUSING

(71) Applicant: LIPPERT COMPONENTS MANUFACTURING, INC., Elkhart, IN (US)

(72) Inventor: Douglas R. SWARTS, Hollister, CA (US)

(21) Appl. No.: 15/425,439

(22) Filed: Feb. 6, 2017

Related U.S. Application Data
(60) Provisional application No. 62/296,792, filed on Feb. 18, 2016.

(51) Int. Cl. E03F 1/00; B65D 51/24; B65D 25/28; F16L 15/00

(52) U.S. Cl. CPC E03F 1/008; F16L 15/007; B65D 51/242; B65D 25/2802; B65D 2525/283

(57) ABSTRACT

A sewer inlet coupler and housing system includes a coupler and a housing containing the coupler. The housing includes a bucket having an open end receiving the coupler and a cap covering the open end of the bucket and the coupler received therein. The cap and coupler include respective features by which the cap may selectively engage, carry, and release the coupler without the need for a user to touch the coupler.

### CROSS-REFERENCE TO RELATED APPLICATIONS

This application claims benefit under 35 U.S.C. §119 of U.S. Provisional Patent Application No. 62/296,792, filed Feb. 18, 2016, and incorporates by reference the disclosure thereof in its entirety.

### BACKGROUND AND SUMMARY OF THE DISCLOSURE

A recreational vehicle (RV) may include sinks, showers and toilets and tanks for holding the waste water therefrom. The holding tanks are of finite capacity and must be drained from time to time. In order to drain the tanks, a first end of a hose may be connected to a tank outlet and a second end of the hose or a nozzle attached thereto may be connected to or otherwise associated with an inlet fitting of a sewage receptacle configured to receive the waste water.

Such sewer inlet fittings are not standardized. As such, a sewer inlet fitting found in one RV park may differ in size from a similar fitting in another RV park. Sewer inlet couplers may be used to enable connection of the second end of the hose or nozzle with varying sizes of fitting. Such sewer inlet couplers are sometimes referred to as step donuts. Also, sewer inlet couplers may include threads about their periphery to enable them to be threaded onto mating threads of a fitting. Such sewer inlet couplers are sometimes referred to as threaded step donuts.

Sewer inlet couplers typically become soiled with waste water when used. It is not always convenient to clean and disinfect a sewer inlet coupler immediately after use, if at all. As such, storage and subsequent use of a used sewer inlet coupler may present sanitary concerns.

### BRIEF DESCRIPTION OF THE DRAWINGS

FIG. 1 is an exploded top perspective view of a sewer inlet coupler and a housing including a bucket and a cap according to the present disclosure;

FIG. 2 is a perspective view of the housing of FIG. 1;

FIG. 3 is a top perspective view of the sewer inlet coupler of FIG. 1;

FIG. 4 is a top perspective view of the bucket of FIG. 1;

FIG. 5A is a top perspective view of the cap of FIG. 1;

FIG. 5B is a bottom perspective view of the cap of FIG. 1;

FIG. 6 is a partially exploded bottom perspective view of the sewer inlet coupler and housing of FIG. 1;

FIG. 7 is a cross-sectional side elevation view of another sewer inlet coupler of FIG. 1 disposed within the housing of FIG. 1;

FIG. 8 is a cross-sectional side elevation view of the sewer inlet coupler of FIG. 7 with a nozzle inserted therein;

FIG. 9 is a an exploded top perspective view of the sewer inlet coupler of FIG. 1 and another housing including another cap and another bucket according to the present disclosure;

FIG. 10 is a cross-sectional side elevation view of the sewer inlet coupler of FIG. 1 disposed within the housing of FIG. 9; and

FIG. 10A is detail view of an interface between the cap of FIG. 9 and the bucket of FIG. 9.

### DETAILED DESCRIPTION OF THE DRAWINGS

Terms of orientation, for example, upper, lower, inner, outer, and the like, may be used herein to reflect relative orientation of components. Such terms should not be construed as referring to absolute orientation unless otherwise dictated by context.

The drawings show illustrative embodiments of a sewer inlet coupler and housing system 10 according to the present disclosure.

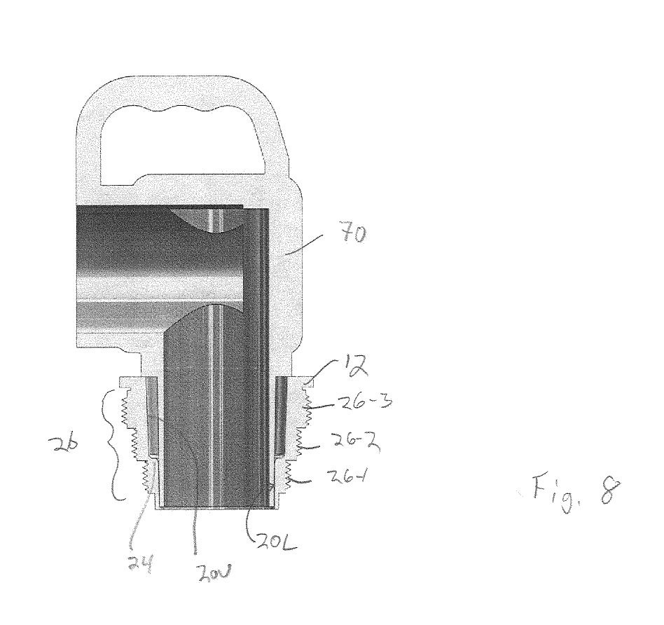

The system 10 includes a sewer inlet coupler 12 and a housing 14 including a bucket 16 and a cap 18. The coupler 12 may be selectively received within the housing 14. As shown in FIG. 8, the system 10 may further include or be used with a nozzle 70 configured for engagement with the coupler 12, as will be discussed further below.

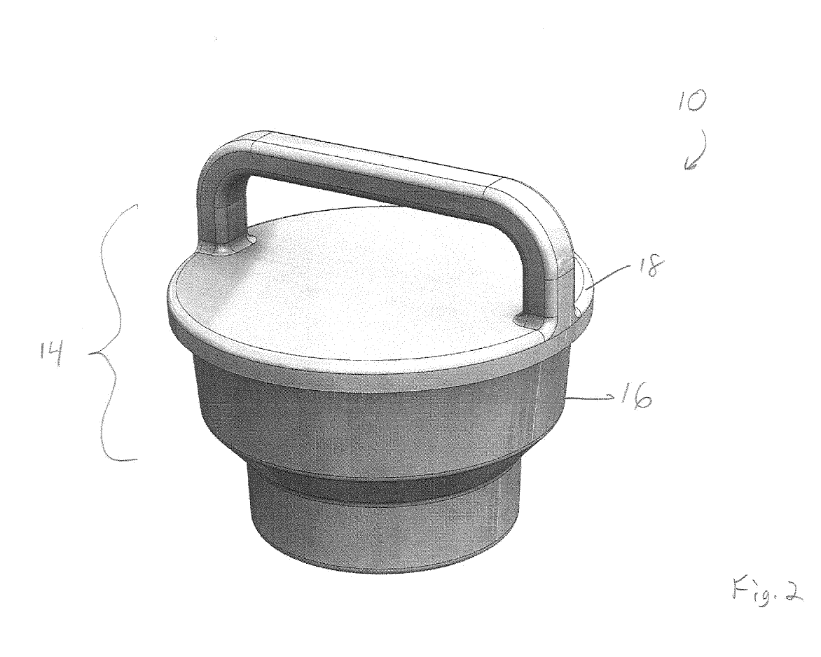

FIG. 2 shows a first embodiment of the housing 14 in an assembled state wherein the cap 18 is attached to an upper end of the bucket 16. With the housing 14 in this configuration, the coupler 12 may be, but need not be, contained therein.

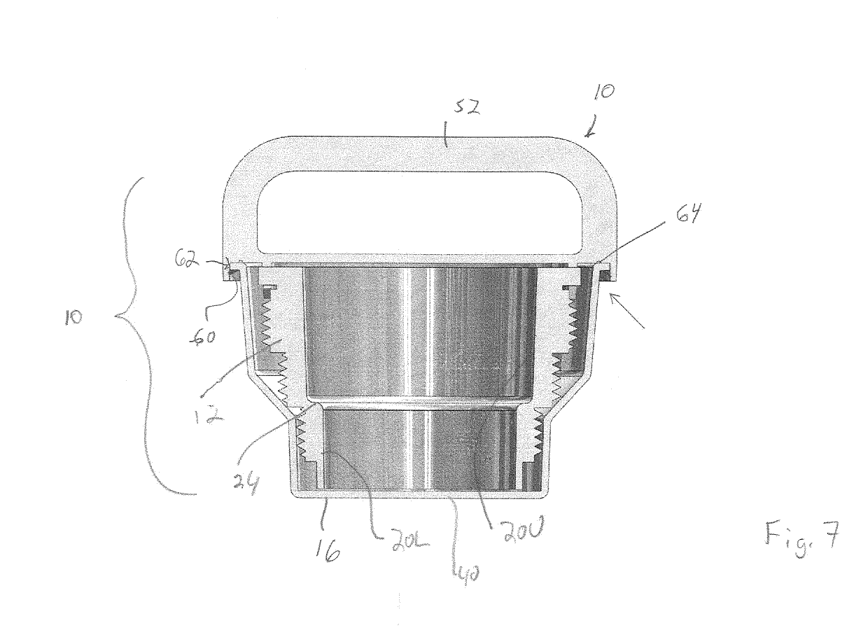

The coupler 12 is generally annular, having an inner wall surface 20 defining an interior region 22 and first and second open ends allowing communication through the coupler from the first open end to the second open end. As best shown in FIGS. 7 and 8, the inner wall surface 20 may be stepped. More specifically, a lower portion 20L of the inner wall surface 20 may have a first nominal inside diameter and an upper portion 20U of the inner wall surface 20 may have a second nominal inside diameter greater than the first nominal inside diameter. (The first and second inside diameters are referred to as nominal diameters because the upper and lower inner wall surface portions 20U, 20L need not have constant diameters. For example, as shown in the drawings, at least the upper inner wall surface portion 20U may define a frustum of a cone having a variable diameter, rather than a cylinder having a constant diameter.)

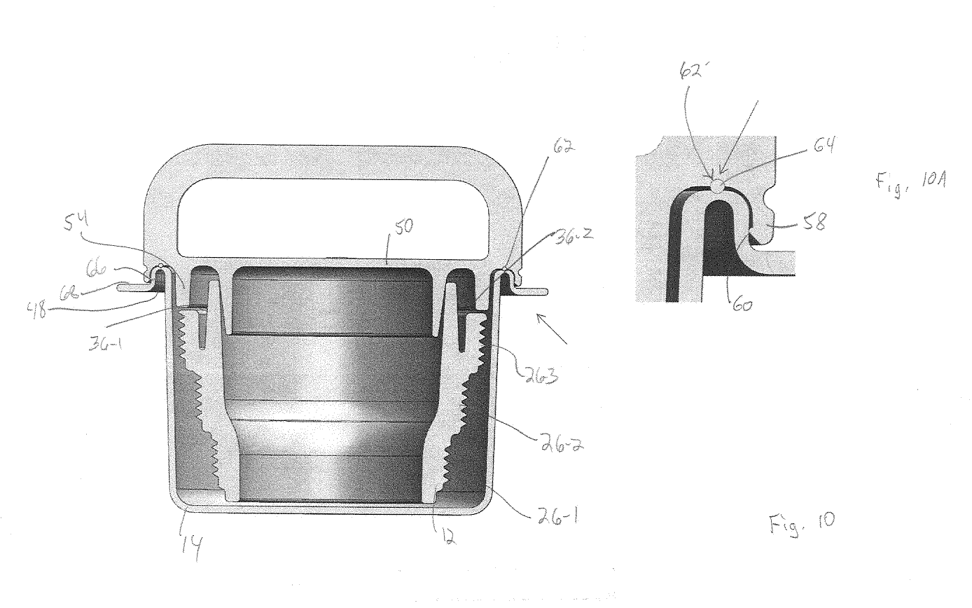

As shown in FIGS. 7 and 8, the transition between the upper inner wall surface portion 20U and the lower inner wall surface portion 20L may define a land or shelf 24 generally perpendicular to the upper and lower inner wall surface portions. In other embodiments, the transition could be oriented in another manner For example, as shown in FIG. 10, the transition could define a swept surface connecting the upper and lower inner wall surface portions 20U, 20L. In an embodiment, the inner wall surface 20 could have an intermediate portion between the lower inner wall surface portion 20L and the upper inner wall surface portion 20U, the intermediate portion having a third nominal inside diameter greater than the first inside diameter and lesser than the second inside diameter. Transitions between the several inner wall surface portions 20i could take any of the forms described above or other forms.

The coupler 12 also has an outer wall surface 26 including a first threaded portion 26-1 having a first outside diameter, a second threaded portion 26-2 having a second outside diameter greater than the first outside diameter, and a third threaded portion 26-3 having a third outside diameter greater than the second outside diameter. The first threaded portion 26-1 is opposite the lower inner wall surface portion 20L. The second and third threaded portions 26-2, 26-3 are shown as being located opposite the upper inner wall surface portion 20U. In another embodiment, the first and second threaded portions 26-1, 26-2 could be adjacent the lower inner wall surface portion 20L, and the third threaded portion 26-3 could be located adjacent the upper inner wall surface portion 20U. Further embodiments could include more or fewer threaded portions 26n. Each threaded portion 26n could include a single helical thread, plural helical threads, or one or more parallel threads (that is, one or more grooves defined by respective pairs of parallel raised portions of the outer wall surface 26).

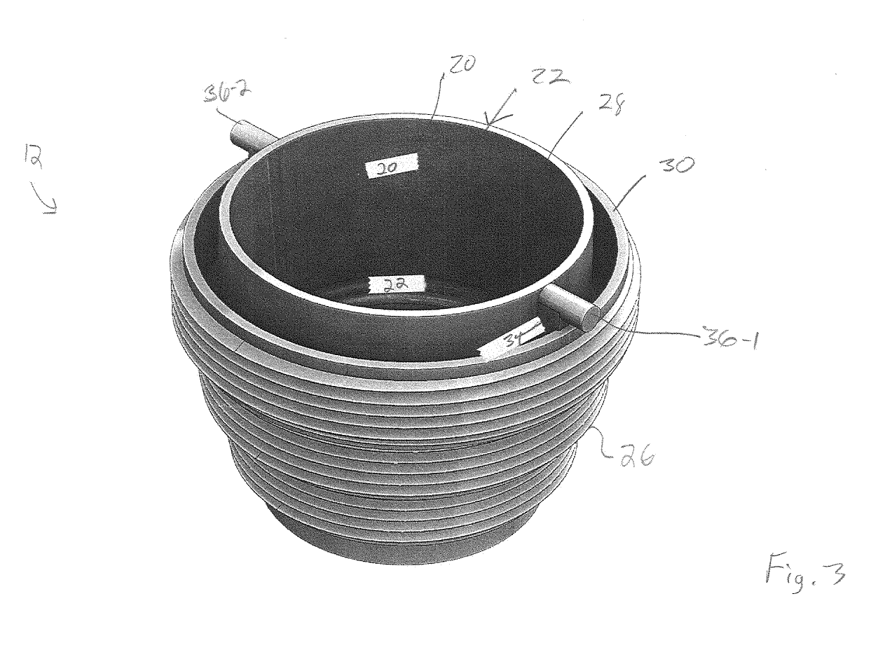

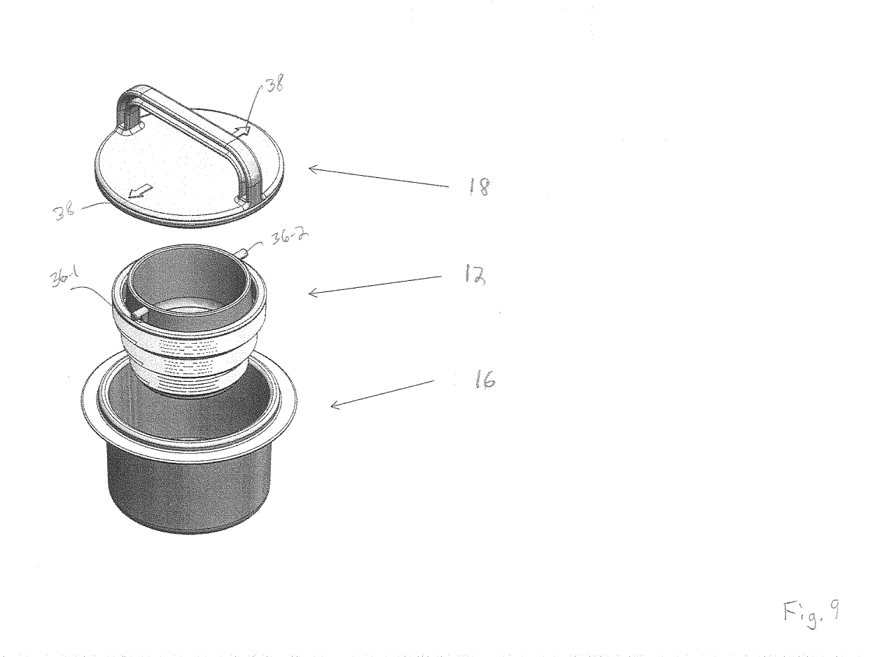

In an embodiment, as best shown in FIGS. 7 and 8, a single sidewall may define both the inner and outer wall surfaces 20, 26 of the coupler 12. In another embodiment, as best shown in FIGS. 3, 9, and 10, at least a portion of the inner wall surface 20 may be defined by an inner sidewall 28 and at least a portion of the outer wall surface 26 may be defined by an outer sidewall 30. In such an embodiment, the inner sidewall 28 and outer sidewall 30 may define a cavity 32 there between. One or more reinforcing bosses 34 may extend radially or otherwise from at least a portion of the inner sidewall 28 to at least a portion of the outer sidewall 30. The inner and outer sidewalls 28, 30 may or may not be joined at respective portions thereof. Joined sidewalls 28, 30, for example, as shown in FIG. 9, may yield a sturdier part. Unjoined sidewalls 28, 30 (or one or more fluid ports (not shown) in communication with the cavity 32 and the interior of the coupler 12) may mitigate the collection of substances that may be introduced in the cavity 32 between the inner and outer sidewalls 28, 30 by channeling such substances toward the interior of the coupler 12. Embodiments including such inner and outer sidewalls 28, 30 may allow for the use of less material for formation of the coupler 12 than embodiments including a single sidewall, particularly if the coupler is relatively large.

The coupler 12 is described above and illustrated as a step-threaded coupler, that is, a coupler having threaded regions of different diameter about its outer wall surface. In other embodiments, the coupler, including its outer wall, could be configured in other ways. For example, the coupler could have a single threaded region about its outer wall surface. In another embodiment, the outer wall surface of the coupler could be unthreaded, with a straight or tapered, smooth or contoured surface. In a further embodiment, the coupler could include a compression fitting or inflatable fitting about its outer wall surface.

The coupler 12 also is described above as having a stepped or tapered interior. In other embodiments, the interior of the coupler could have a generally constant, for example, cylindrical, cross-section. A minimal degree of taper may be provided to facilitate release from a mold in which the coupler may be formed.

Also as best shown in FIGS. 3, 9, and 10, first and second pins 36-1, 36-2 extend radially outwardly from diametrically opposed portions of an outer surface of the inner sidewall 28. In other embodiments, the first and second pins 36-1, 36-2 could extend from other portions of the outer surface of the inner sidewall 28 or from other portions of the coupler 12. For example, the first and second pins 36-1, 36-2 could extend from an outer surface of the outer sidewall 30. Also, in an embodiment including a single sidewall instead of inner and outer sidewalls 28, 30, the pins 36-1, 36-2 could extend from an outer surface of the sidewall. Other embodiments could include more or fewer than two pins 36n. For example, an embodiment could include three, four, five, or more equally or unequally spaced apart pins 36n extending radially outwardly from the inner wall or other portion of the coupler. In embodiments including inner and outer sidewalls 28, 30 and bosses 34 extending there between, the pins 36n may be coextensive with the bosses.

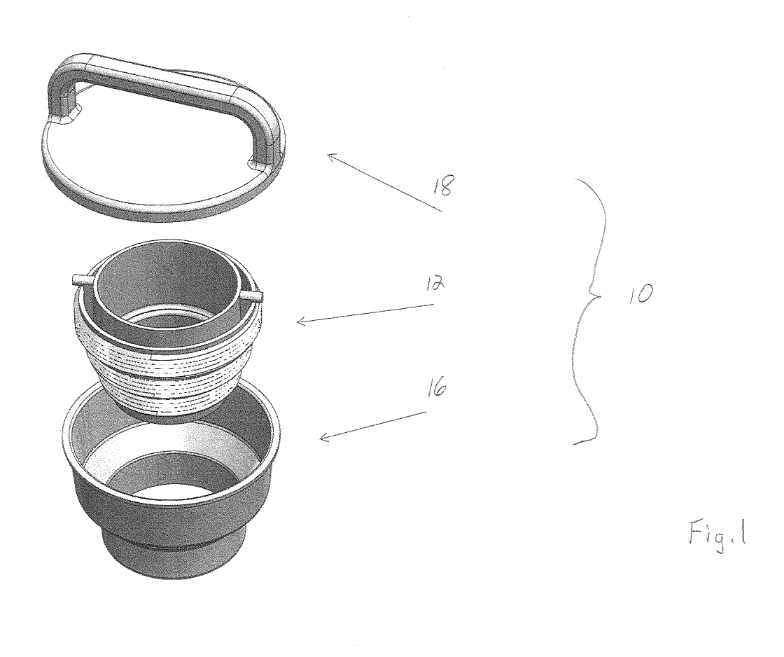

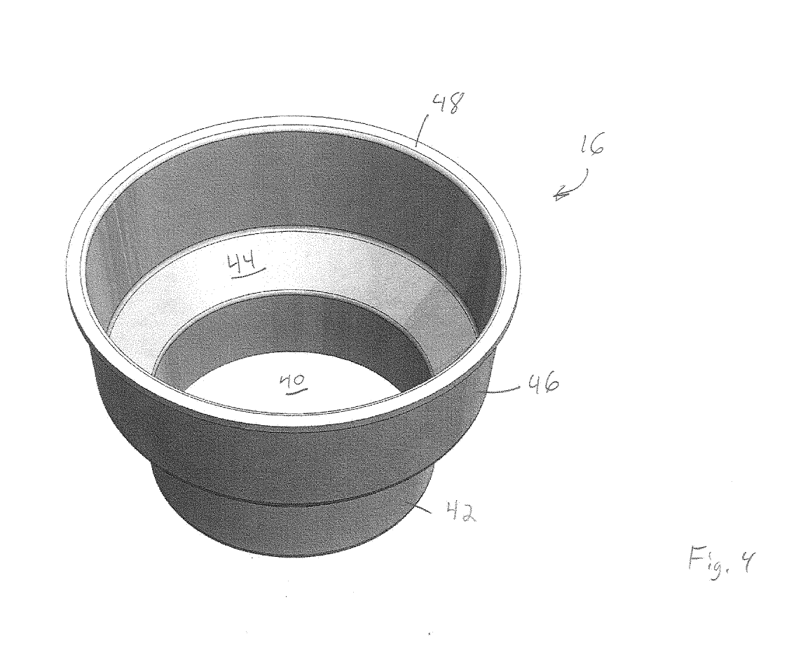

As best shown in FIGS. 4, 7, and 10, the bucket 16 includes a generally circular bottom 40 and a side wall extending upwardly therefrom. The bottom 40 is shown as planar but could have another profile in another embodiment. In an embodiment, for example, as shown in FIGS. 9 and 10, the bucket 16 may be generally right cylindrical. In another embodiment, the bucket 14 may have a shaped sidewall. For example, FIGS. 1-6 show an embodiment of a bucket 14 wherein a lower ring 42 extends upwardly from the bottom 40. The lower ring 42 is defined by a sidewall that is generally perpendicular to the bottom 40. In another embodiment, the lower ring 42 could extend upwardly and either inwardly or outwardly from the bottom 40. A transition ring 44 extends upwardly and outwardly from an upper portion, for example, an upper end, of the lower ring 42. An upper ring 46 extends upwardly and outwardly from an upper/outer portion, for example, an outer/outer end, of the transition ring 44. A lip 48 extends radially outwardly from an upper portion, for example, an upper edge, of the upper ring 46. In an embodiment, for example, as shown in FIGS. 9 and 10, a return 66 may extend downwardly from the lip 48. A flange 68 may extend outwardly from the return 66. In other embodiments, the bucket 14 may be shaped in other ways.

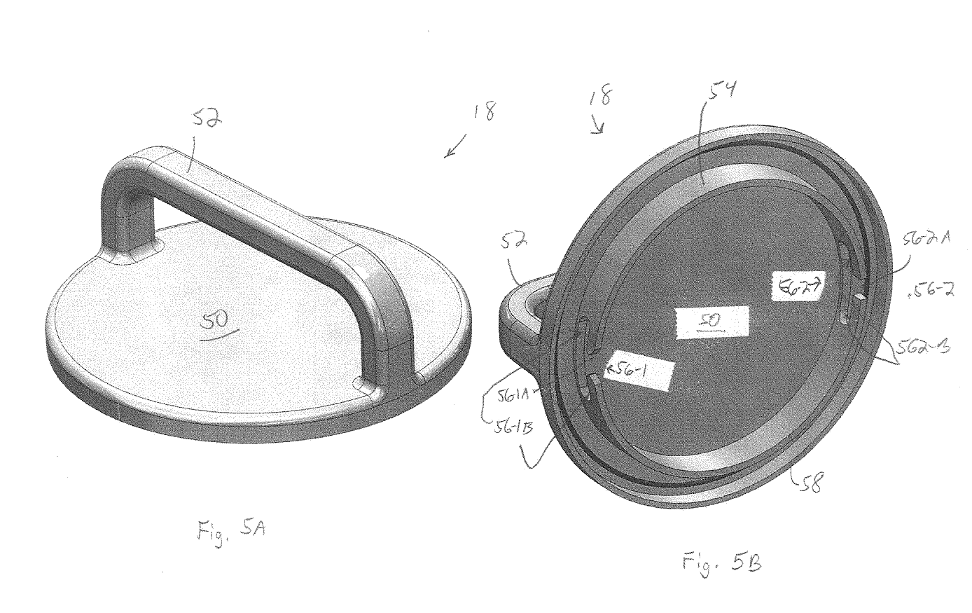

As best shown in FIGS. 5A and 5B, the cap 18 includes a generally circular top 50. A handle 52 extends from an outer or upper surface of the top 50. The handle 52 is shown as U-shaped and attached to the top 50 at diametrically-opposed outer edges thereof, but the handle could be configured and connected to the top in other manners. Typically, the handle 52 would extend laterally from and linearly across the outer surface of the top 50. A first or inner ring 54 extends downwardly from a lower or inner surface of the top 50. The inner ring 54 is spaced away from the edge of the top 50. The inner ring 54 defines first and second generally T-shaped slots 56-1, 56-2 located at diametrically-opposed portion thereof. Each of the T-shaped slots 56-1, 56-2 includes a first portion 56A extending upwardly from the free edge of the inner ring 54 toward the top 50, and a second portion 56B extending circumferentially in first and second directions from the first portion and generally perpendicular thereto. In other embodiments, the inner ring 54 could define more or fewer T-shaped slots 56n. Typically, the number and arrangement of T-shaped slots 56n would correspond to the number of and arrangement of pins 36n extending from the coupler 12. In an embodiment, the slots 56n could be L-shaped instead of T-shaped, wherein the second portions 56B of the slots could extend in only one direction, rather than in two directions, from the first portion 56A. The inner ring 54 is shown as a continuous, annular ring. In an embodiment, the inner ring 54 could be embodied as one more flanges, for example, one or more discontinuous ring segments, extending downwardly from the lower or inner surface of the top 50.

A second or outer ring 58 extends downwardly from the lower or inner surface of the top proximate the edge of the top. An inner surface of the outer ring 58 may define a lip 60 that cooperates with the bucket 16 to securely but releasably engage the cap 18 with the bucket. A lower portion of the top 50 may define a shallow groove 62 configured to receive an o-ring or other seal 64. A similar, corresponding groove may be defined by the lip 48 of the bucket 16. The seal 64 may mitigate or reduce the likelihood of vapor, liquid, or gas escaping from the housing 14 when the cap 18 is attached to the bucket. In other embodiments, the housing 14 may include other features configured to mitigate or reduce the likelihood of vapor, liquid, or gas escaping from the housing 14 when the cap 18 is attached to the bucket.

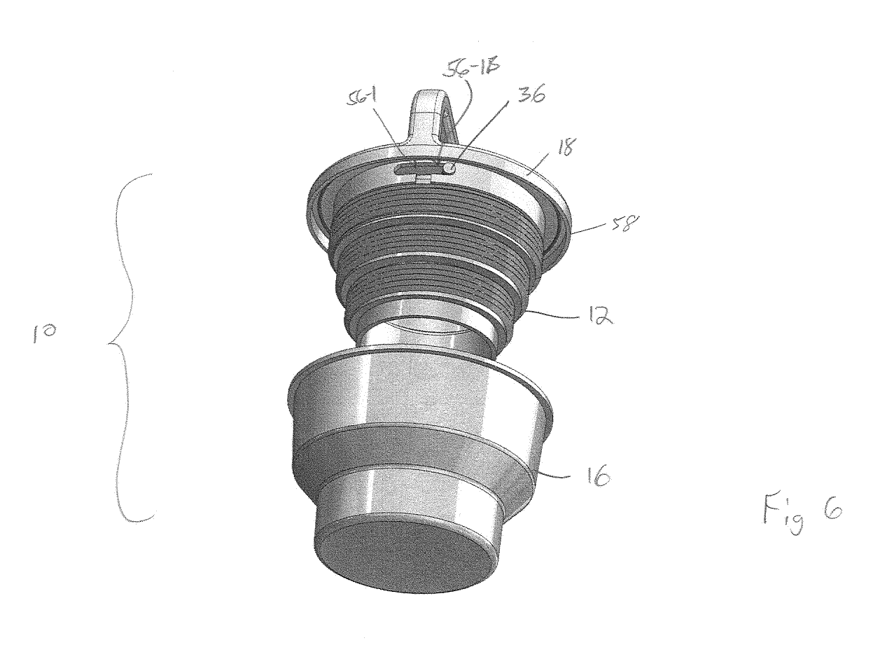

As best shown in FIG. 6, the T-shaped slots 56n of the cap 18 may selectively engage with the pins 36n extending outwardly from the coupler 12. More specifically, the first portion of the T-shaped slots 56n of the cap 18 may be aligned with respective pins 36n of the coupler 12. The cap 18 may then be moved toward the coupler 12 so that the pins 36n are fully received within the first portion of the corresponding T-shaped slots 56n. The cap 18 may then be rotated with respect to the coupler 12 so that the pins 36n become fully received within the second portion of the corresponding T-shaped slots 56n, that is, so that the pins 36n come to rest against the blind end of the second portions of the corresponding T-shaped slots 56n. Once the pins 36n and T-shaped slots 56n are engaged in this manner, the cap 18 can be used to carry the coupler 14 from one location to another. For example, the cap 18 can be used to carry the coupler 12 from the bucket 16 to a sewer inlet fitting (not shown) or vice versa. The pins 36n may be released from the T-shaped slots 56n by the reverse procedure. In this manner, a user may pick up the coupler 12 and move it from the bucket 16 to the sewer inlet fitting and vice versa without touching the coupler 12. In order to facilitate engagement of the slots 56n of the cap 18 with the corresponding pins 36n of the coupler 12, the cap 18 may be provided with alignment arrows 38 or similar markings. The arrows may be printed onto, molded into, or otherwise associated with the cap 18.

In other embodiments, the coupler 12 and cap 18 may include other engagement features and complementary engagement features by which the cap may selectively engage and disengage with and carry the coupler without the need for a user to touch the coupler.

As best shown in FIG. 7, the coupler 12 can be stored in the housing 14 by placing the coupler into the bucket 16 using the foregoing technique or any other suitable technique, and then attaching the cap 18 to the bucket. The cap 18 maybe pressed onto the bucket 16 so that the upper edge or lip 48 of the bucket becomes releasably secured, for example, to the inner surface of the outer ring 58 or lip 60 of the cap 18. The foregoing securement features alone may be sufficient to provide an acceptable seal between the cap 18 and the bucket 16. A better seal or hermetic seal between the cap 18 and the bucket 16 may be afforded by providing the seal 64 as discussed above. In an embodiment, it may be desirable to forego a hermetic seal so as to provide ventilation between the interior and exterior of the housing 14 sufficient to release pressure that may build up within the housing due to temperature changes or decomposition of matter therein when the cap 18 is secured to the bucket 16.

As best shown in FIG. 8, the inner surface of the coupler 12 can be configured to receive the nozzle 70, which may be attached to the free end of a hose having another end connected to a waste water tank on an RV. For example, the coupler 12 can be configured to receive the nozzle 70 in sliding engagement with or otherwise within the lower portion 20L of the inner surface 20 of the coupler. In another embodiment, the coupler 12 can be configured to receive the nozzle 70 in sliding engagement with or otherwise within the upper portion 20U of the inner surface 20 of the coupler. The nozzle 70 as shown is illustrative and not limiting. Any form of nozzle or fitting compatible receivable within the coupler 12 could be used in lieu of the nozzle 70 as shown and described.

Features described herein in connection with a particular embodiment may be combined with features described herein in connection with other embodiments unless otherwise noted or not possible.

1. A system comprising:
a bucket, said bucket comprising:
a bottom, and
a side wall extending upwardly from said bottom;
a generally annular coupler selectively receivable in said bucket, said coupler comprising:
an inner surface defined by a lower sidewall portion having a first inside diameter and an upper sidewall portion having a second inside diameter greater than said first inside diameter;
an outer surface defined by a first portion having a first outside diameter and a second portion having a second outside diameter greater than said first outside diameter; and
first and second pins extending radially outwardly from an upper portion of said coupler; and
a cap retainably and releasably attachable to said bucket with said coupler received in said bucket, said cap comprising:
a top defining an upper surface and a lower surface;
a handle extending axially upwardly from said upper surface;
a first ring having a first diameter extending axially downwardly from said lower surface, said first ring defining first and second slots extending from a lower edge thereof, each of said first and second slots having a first portion extending toward said top from said lower edge of said first ring and a second portion extending in a first direction generally perpendicularly from an end of said first portion opposite said lower edge of said first ring, each of said first and second slots configured to selectively receive one of said first and second pins; and
a second ring having a second diameter greater than said first diameter extending downwardly from said lower surface; said second ring having an inner surface configured to selectively engage with said upper ring of said bucket.

2. The system of claim 1, said bucket further comprising a lip extending radially outwardly from an upper portion of said side wall, and said inner surface of said second ring of said cap configured to selectively engage with said lip.

3. The system of claim 1, said bucket further comprising a lip extending radially outwardly from an upper portion of said side wall, and said cap further comprising a lip extending radially inwardly from said second ring, said lip of said bucket configured to selectively engage with said cap.

4. The system of claim 1, at least a portion of said inner surface of said coupler defined by a first sidewall and at least a portion of said outer surface of said coupler defined by a second sidewall, said coupler further comprising a cavity between said first sidewall and said second sidewall.

5. The system of claim 4, said coupler further comprising at least one boss extending between said first sidewall and said second sidewall.

6. The system of claim 5, said at least one boss coextensive with one of said first and second pins, said one of said first and second pins extending radially outwardly beyond said at least one boss.

7. The system of claim 1, said second portion of each of said first and second slots further extending in a second direction generally perpendicularly from an end of said first portion opposite said lower edge of said first ring,

8. The system of claim 1 wherein said second ring of said cap selectively engages with an upper portion of said bucket via an interference fit.

9. A system comprising:
a bucket comprising:
a bottom and
a sidewall connected at a lower portion thereof to said bottom;
a generally annular coupler selectively receivable in said bucket, said coupler comprising:
an outer surface;
an inner surface; and
at least one engagement feature configured to selectively engage a complementary engagement feature; and
a cap selectively attachable to said bucket with said coupler received in said bucket, said cap comprising:
a top defining an upper surface and a lower surface;
said complementary engagement feature extending downwardly from said lower surface; and
a ring extending downwardly from said lower surface; said cap configured to removably and retainably engage with an upper portion of said bucket.

10. The system of claim 9, said engagement feature comprising a pin extending radially outwardly from an upper portion of said coupler.

11. The system of claim 10, said complementary engagement feature comprising a flange extending downwardly from said top of said cap, said flange defining a slot configured to removably and retainably receive said pin.

12. The system of claim 11, said engagement feature further comprising a second pin extending radially outwardly from said upper portion of said coupler, and said flange defining a second slot configured to removably and retainably receive said pin.

13. The system of claim 12, said flange comprising a second ring.

14. The system of claim 11, said engagement feature further comprising a second pin extending radially outwardly from said upper portion of said coupler, said complementary engagement feature comprising a flange extending downwardly from said top of said cap, said flange defining a slot configured to removably and retainably receive said pin, and said complementary engagement feature further comprising a second flange extending downwardly from said top of said cap, said second flange defining a second slot configured to removably and retainably receive said second pin.

15. The system of claim 11, said slot having a first portion extending toward said top from an edge of said flange opposite said top and a second portion extending in a first direction from said first portion, said first direction generally parallel to said top.

16. The system of claim 15, said second portion further extending in a second direction from said first portion, said second direction generally parallel to said top.

17. The system of claim 9, said cap further comprising a handle.

18. The system of claim 9, said cap further comprising an elongated handle extending axially from and linearly across said upper surface of said top.

19. The system of claim 9, at least one of said upper portion of said side wall and said lower surface of said top defining a groove configured to receive a seal.

20. The system of claim 19 further comprising said seal disposed in said groove.
